(19) United States
(12) Patent Application Publication
(10) Pub. No.: US 2005/0117068 A1
(43) Pub. Date: Jun. 2, 2005

(54) System and method for the wireless transmission of audio and video information

(75) Inventors: Donald W. Moses, Eagan, MN (US); Charles H. Hustig, The Villages, FL (US)

Correspondence Address: HAYNES AND BOONE, LLP, 901 MAIN STREET, SUITE 3100, DALLAS, TX, 75202, US

(73) Assignee: Medea Design Group, Inc., Eagan, MN (US)

(21) Appl. No.: 10/954,564

(22) Filed: Sep. 30, 2004

Related U.S. Application Data
(60) Provisional application No. 60/507,608, filed on Sep. 30, 2003.

(51) Int. Cl. H04N 7/04

(52) U.S. Cl. 348/723; 348/469

(57) ABSTRACT

A wireless transmission system and method according to which an audio signal and a video signal are combined, the combined signals are transmitted, and then separated back into a separate video signal and a separate audio signal.

### CROSS REFERENCE

This application is based on, and claims priority of, provisional application Ser. No. 60/507,608 which was filed by applicants on Sep. 30, 2003.

### BACKGROUND

The present invention relates to a system and method for transmitting audio and video signals over a wireless network and, more particularly, to such a system and method featuring encryption and diversity and transmission at a relatively low cost.

There are many applications in which the wireless transmission of audio and video signals would be highly desirable. For example, in commercial or home entertainment applications the standard technique of providing hard wiring between audio source components and amplifiers and/or loudspeakers, as well as between video source components and video displays is often difficult, time consuming and inconvenient. These same problems also exist in commercial or professional venues such as live concerts, down hole oil and gas recovery systems, and the like.

### BRIEF DESCRIPTION OF THE DRAWING

FIG. 1 is a flowchart of one embodiment of a method for transmitting a signal containing audio and video information.

FIG. 2 is a flowchart of one embodiment of a method for receiving a signal transmitted using the method of FIG. 1.

FIG. 3 is a schematic diagram of one embodiment of a system within which the methods of FIGS. 1 and 2 may be implemented.

FIG. 4 is a diagram of a signal that may be used with the system of FIG. 3.

### DETAILED DESCRIPTION

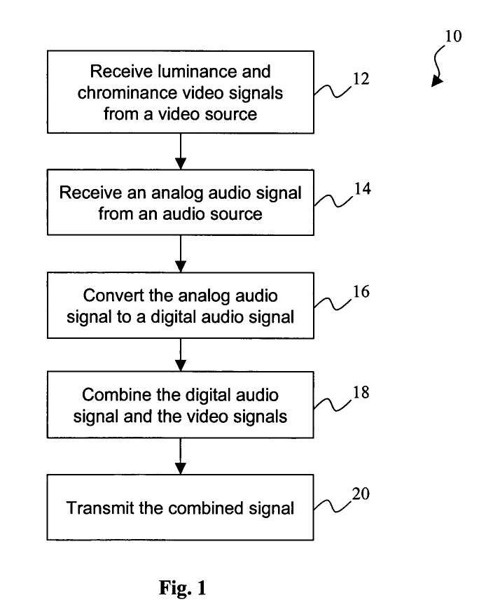

Referring to FIG. 1, in one embodiment, a method 10 may be used to transmit audio and video information using a wireless signal. As will be described below in greater detail with specific examples, the method 10 enables composite video signals as well as luminance and chrominance video signals (hereinafter collectively referred to as “analog video signals”) to be wirelessly transmitted along with a digital audio signal in a single combined signals. The analog video signals are maintained in their original analog form, and the audio signals are either received in the digital domain, or if received in an analog domain, are converted to digital. The combination of the digital audio signals and the analog video signals (hereinafter collectively referred to as “combined signals”) may be analyzed for errors at the receiver location using the digital audio signal component. In a diversity system having multiple reception channels, a receiver may use the error analysis to select a channel providing the best (e.g., most error free) reception. In addition, the digitized audio signal may be used to provide encryption/validation functionality for the combined signals. For example, validation of the audio signal's encryption may be used to validate the combined signals. Accordingly, the analog video signals may remain in the analog and still enjoy the benefits of diversity and encryption provided by the digital audio signal.

In steps 12 and 14, the analog video signals are received from a video source and an audio signal is received from an audio source. The audio signal is digitized in step 16 (assuming that the audio signal is not already in digital form) and combined with the video signals in step 18. In step 20, the combined signals is transmitted via a wireless transmitter. As will be described below, various other actions may be taken, including encrypting the digital audio signal.

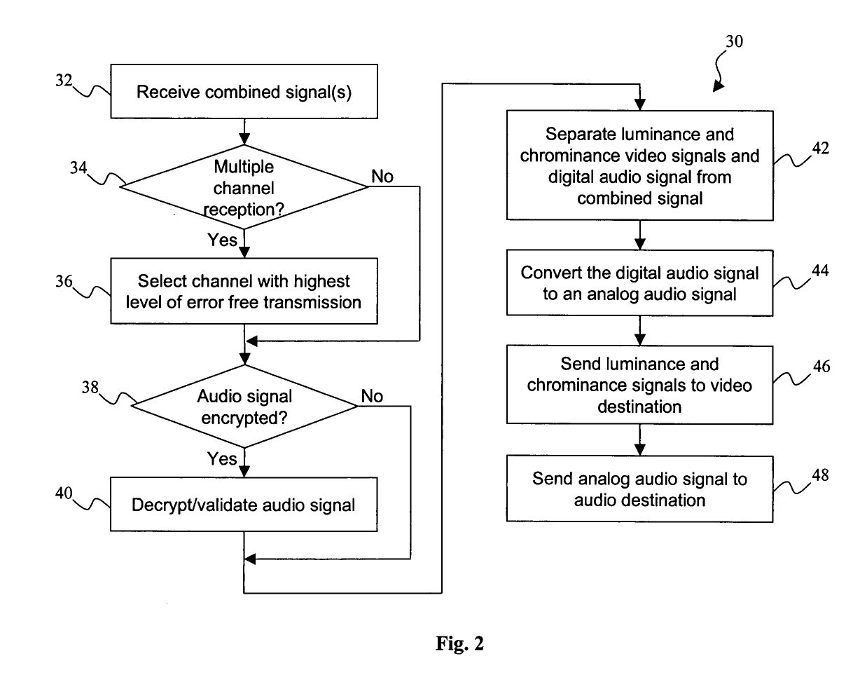

Referring to FIG. 2, one embodiment of a method 30 illustrates a process by which a wirelessly transmitted combined signals (such as that transmitted using the method 10 of FIG. 1) may be received and separated into its component signals. More specific examples of various steps of FIG. 2 will be described later.

In step 32, a combined signal is received that contains the analog video signals and a digital audio signal. In step 36, if the receiver includes a diversity system that provides multiple reception channels (as determined in step 34), the best channel (e.g., the channel with the highest level of error free transmission) is selected and the incoming signal is pulled from that channel. In step 40, if the audio signal is encrypted (as determined in step 38), the audio portion of the signal is decrypted. This step may include validation of the audio signal (and the associated video signals), with the receiver ensuring that the destination has permission to receive the unencrypted signal, and the accompanying analog video signal. In step 42, the analog video signals and the digital audio signals are separated from the combined signals. In step 44, the digital audio signal is converted into an analog audio signal (if needed). In steps 46 and 48, respectively, the analog video signals are sent to a video destination and the audio signal is sent to an audio destination.

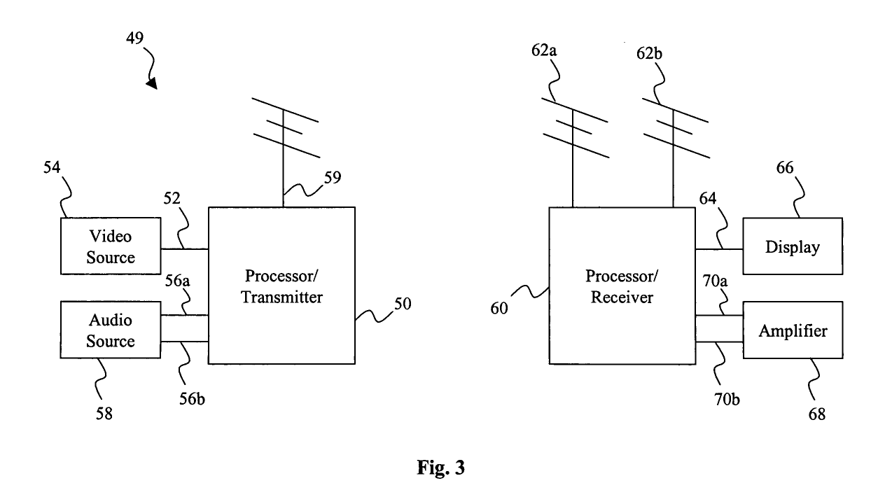

Referring to FIG. 3, an embodiment of the present invention is shown in connection with an audio/video home or commercial entertainment system 49 for the purpose of example only. The embodiment includes a processor/transmitter 50 having a conventional video input terminal, or jack, to which one end of a cable 52 is connected, via a conventional connector. The other end of the cable 52 is connected, also via a conventional connector, to a video source 54 which could be a television receiver, a cable television source, a satellite receiver/processor, a DVD player, a video recording/playback deck, a camera, or any other source. The analog video signals from the source 54 and passed to the processor/transmitter 50, via the cable 52.

The processor/transmitter 50 also has two conventional audio input terminals, or jacks, to which one end of each of two audio cables 56a and 56b are respectively connected, via conventional connectors. The other ends of the cables 56a and 56b are connected to an audio source 58 which could be one of the same sources set forth above, or a tape deck, a CD player, a DAT player, a record player, a FM or AM tuner, or any other type of audio source.

The audio source signals are outputted from the source 58 and passed to the processor/transmitter 50, via the cables 56a and 56b. It can be appreciated that the two audio signals could represent a stereo signal and that the number of inputs, connectors and cables could be increased to accommodate any number of channels, or discrete signals, in a multichannel audio surround system, such as SACD (super audio compact disc) surround and DVD (digital versatile disc) audio surround, all of which are conventional. Also, the source 58 could output a single digital audio signal such as 5.1 Dolby digital, DTS or the like, in which case the cable 56a (or 56b) would be adapted to pass the latter signal to the processor/transmitter 50.

The processor/transmitter 50 includes circuitry, in the form of limiters, modulators, converters, generators, multiplexers, transformers, and associated circuitry to process the video signals received at the video input and the audio signals received at the audio inputs in the following manner.

If the analog video signal received from the video source 54 consists of luminance and chrominance signals, the luminance signal is processed to maintain DC integrity and is band-limited with a low pass filter (such as 6 MHz). A modulator modulates the chrominance signal onto a carrier frequency (such as 15 MHz), band-limited between a predetermined range (such as between 12 and 18 MHz), the modulated signal is added to the luminance signal, and the combined signals are transmitted from the processor/transmitter 50 in a manner to be described.

If the analog video signal received from the video source 54 consists of a composite signal, the composite signal is processed to maintain DC integrity and is band-limited with a low pass filter (such as 6 MHz) and the signal is transmitted from the processor/transmitter 50 in a manner to be described.

The processor/transmitter 50 also includes circuitry, including analog-to-digital converters, digital circuitry, clock frequency generators, multiplexers, synchronizers, spreaders, encryptors, transformers, and associated circuitry to process the audio signals received at the audio inputs in the following manner.

If the audio signals are analog, they are converted to corresponding digital signals utilizing analog-to-digital converter integrated chips and applied to a digital circuit such as an ASIC (application-specific integrated circuit—a chip designed for a particular application. The digital processing includes the steps of:
1. generating the clock frequencies to run the analog-to-digital converters;
2. multiplexing the data portions of the digitized audio signals into one bit stream;
3. adding synchronizing information to the bit stream; and
4. adding a spreading code and/or an encryption code to the bit stream.

The assembled bit stream is then transformed into a transmission code that is bandwidth limited from a certain frequency range (such as 6 MHz to 12 MHz, for example). Examples of acceptable transmission codes include bi-phase digital coding, di-phase coding, Manchester coding, DDS (digital direct sequence—a type of spread spectrum coding) combined with FSK (frequency shift keying—a method of modulation where the frequency is shifted to higher frequencies, then to lower frequencies to signify a logic “1” or “0”) modulation of a 9 MHz or other carrier, frequency modulation of a 9 MHz or other carrier, or ASK (amplitude shift keying, a type of modulation where the amplitude of a radio signal is shifted up and down in amplitude in order to signify a logic “1” or “0”) modulation of a carrier.

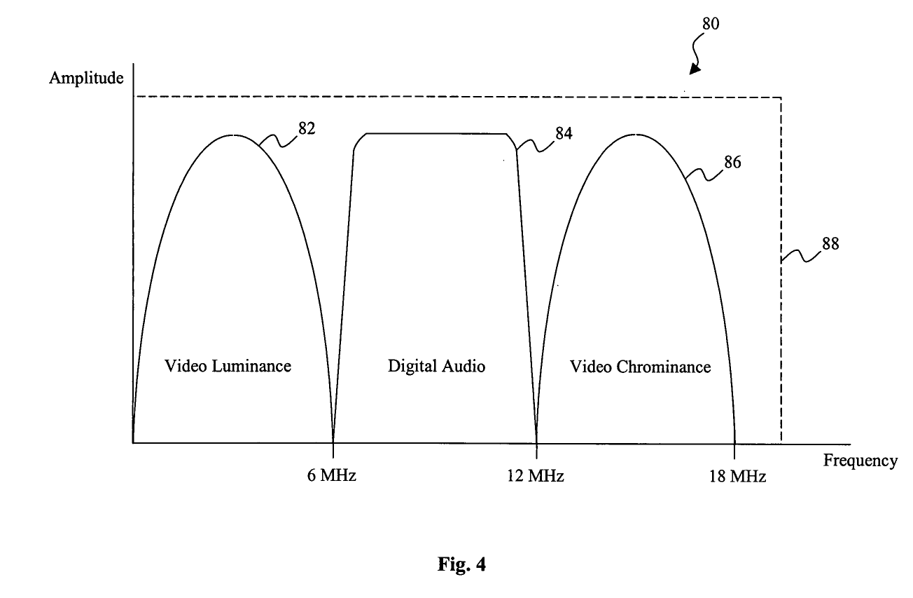

With additional reference to FIG. 4, and assuming that the analog video signal consists of luminance signals and chrominance signals, a chart 80 provides an amplitude/frequency illustration of how these signals, and the audio signal is combined. In this embodiment, the band-limited digital audio signal 84 is added to the luminance video signal 82, and chrominance video signal 86 from the above video circuitry in the processor/transmitter 50 with the above frequency range (6 MHz to 12 MHz) of the digital audio signal lying between the frequency range (up to 6 MHz) of the luminance video signal and the frequency range (12 MHz to 18 MHz) of the chrominance video signal. A dotted line 88 illustrates that the transmitted band is 20 MHz wide.

It is understood that this particular arrangement of signals (e.g., luminance, audio, and chrominance in sequentially increasing frequency slots) is for purposes of illustration only and the signals may be arranged differently. In the present example, the luminance signal is placed in the lowest frequency slot because this is the spectrum location from which the luminance signal is received using an S-video cable. The audio is placed in the middle frequency slot because this matches the spectrum where the digital audio signal will appear using at least some of the previously referenced modulation schemes. When the chrominance signal is received, it is overlapping the luminance signal and needs to be shifted. By shifting the chrominance signal to the highest frequency slot, only one of the three signals needs to be shifted. This may reduce the cost of the system 49 by avoiding unnecessary shifting. However, it is understood that any of the signals may be moved to any of the frequency slots, and that different arrangements of signals may be desired to handle different situations (e.g., if a different modulation scheme is used).

If the analog video signal is a composite signal it would be in the lowest frequency slot, as defined above, there would not be a highest frequency slot.

Referring again specifically to FIG. 3, the combined signals are modulated onto an RF (radio frequency) carrier such as at a frequency between 5.725 GHz and 5.825 GHz according to FCC or international requirements. The RF carrier is generated by a frequency synthesizer and transmitted from the processor/transmitter 50 in this form. To this end, the processor/transmitter 50 includes, or is connected to, an antenna 59, for transmitting the signals from the processor/transmitter. The antenna 59 can be of the type disclosed in pending U.S. patent application Ser. No. 10/215,704 assigned to the same assignee as the present application, the disclosure of which is incorporated by reference.

A receiver/processor 60 is provided in proximity to the processor/transmitter 50 and includes, or is connected to, two antennas 62a and 62b. It is understood that, although the antennas 62a and 62b are illustrated separately, they may be contained on a single antenna board. The antennas 62a and 62b may be similar or identical to the antenna 59 and are adapted to receive the transmitted signals from the latter antenna and pass the signals to the receiver/processor 60. In this context, the receiver/processor 60 includes a diversity system of the type taught in U.S. Pat. No. 6,788,751 and in U.S. patent application Ser. No. 09/552,471, the disclosures of which is incorporated by reference. The diversity system is discussed below.

The receiver/processor 60 also includes circuitry, including one or more amplifiers, filters, mixers, generators, synthesizers, filters, demodulators or discriminators, combiners, equalizers, bufferers, encryption pass/fail switches, and associated circuitry, to process the video and audio signals received from the processor/transmitter 50 in the following manner.

Two RF signals, each including the combined audio and video signals, from the two antennas 62a and 62b, respectively, are received by the receiver/processor 60 utilizing the diversity system discussed above. In particular, and as disclosed in the above mentioned U.S. patent and patent application, this diversity system, in general, involves processing and analyzing the two combined signals from the two antenna 62a and 62b, respectively, and selecting the optimum signal in accordance with the following.

The processing at the receiver/processor 60 includes amplifying the resulting RF signal, including the combined audio and video signals, by a low noise amplifier stage, band-pass filtered, and applying it to the RF input of a double balanced mixer. An LO (local oscillator—a oscillator that is used to combine with other frequencies to form sum and difference frequencies) signal is generated by a frequency synthesizer and applied to an appropriate input of the double balanced mixer. The RF signal is mixed with a local oscillator (LO) frequency signal in the mixer to generate a resultant intermediate frequency (IF) signal that is generally at a lower frequency so filtering, amplification and demodulation are easier.

The intermediate frequency signal is outputted from the double balanced mixer, is amplified as necessary to achieve the required sensitivity, and is band-pass filtered at the intermediate (sum or difference) frequency. The intermediate frequency signal is either mixed again to establish a second intermediate frequency or the first intermediate frequency is demodulated or discriminated utilizing standard techniques to retrieve the compiled analog video signals and the digital audio signal.

If the analog video signals are luminance and chrominance video signals, the resulting RF signal is DC restored, amplitude-equalized and buffered and the chrominance signal is demodulated, amplitude-equalized, and buffered. The receiver/processor 60 outputs the separate luminance and chrominance video components of the process signal via a conventional video output terminal, or jack, to which one end of a video cable 64 is connected. The cable 64 can be a standard video cable, such as an S-video cable, and its other end is connected to a video display 66 such as a television set, a plasma monitor, a front projector, a rear projector, a LCOS monitor, a LCD monitor, or the like.

The receiver/processor 60 also includes circuitry, including a digital processor, a digital-to-analog converter, and associated circuitry, to process the audio signals in the resulting RF signal in the following manner.

The digital audio signals are processed by the digital processor whose functions include:
1. clock recovery,
2. de-encryption,
3. demultiplexing,
4. error detection, correction, and concealment,
5. diversity selection (if applicable), and
6. I²S (a standard digital audio format which uses 3 wires, data, data clock and Left-Right clock formatting).

The I²S-formatted signals are converted to analog audio information by means of the digital-to-analog converters, are filtered and are outputted from the receiver/processor 60 via two conventional audio output terminals, or jacks, to which one end of each of two audio cables 68a and 68b are respectively connected. The other ends of the cables 68a and 68b are connected to an audio amplifier 70 for amplifying the audio signals. It is understood that the audio amplifier 70 could be associated with, or separate from, the display 66 or the receiver/processor 60. In any case, the amplifier 70 amplifies the signals received from the receiver/processor 60, and is connected to loudspeakers (not shown) for reproducing the audio signal in a conventional manner. The loudspeakers can be built into the display 66 or could be stand-alone.

The number of audio signals passed from the receiver/processor 60 to the amplifier 70 could vary to accommodate any number of channels, or discrete signals, in a multichannel audio surround system, such as SACD surround and DVD audio surround, all of which are conventional. Also, the receiver/processor 60 could output a single digital audio signal such as 5.1 Dolby digital, DTS, or the like.

It is understood that the circuitry of the receiver/processor 60, from the low noise amplifier to the demodulator or discriminator, can be duplicated one or more times to create multiple receiving devices which correspond in number to the number of antennas, which in this example are antennas 62a and 62b. In this context, two or more of the above functions can be combined for diversity in the manner discussed above and taught in the above-mentioned patent and patent application.

The above embodiment permits a relatively low cost, wireless transmission of audio and video featuring encryption for privacy, digital audio for high quality audio, synthesized tuning for selectivity and stability, and in the case where the analog video signals are separated luminance and chrominance signals, these signals are separated for high video quality.

It is understood that variations may be made in the above without departing from the scope of the invention. For, example the number of antennas and the number of corresponding receiver/processor circuits can be increased within the scope of the invention. Also, the expression “signal” is used above in a broad sense and, as such, is meant to cover one signal or a plurality of signals. Further, any conventional type of antennas and diversity systems can be used. Moreover, the embodiment described above is not limited to use with a home audio/video entertainment system, but rather is applicable to any other environment in which wireless transmission of signals is desired. Also, it is understood that the above embodiment is equally applicable to stand-alone audio applications as well as stand-alone video applications. In addition, various steps of the described methods may be executed in a different order or executed sequentially, combined, further divided, replaced with alternate steps, or removed entirely. Also, various functions illustrated in the methods or described elsewhere in the disclosure may be combined to provide additional and/or alternate functions.

Although only a few exemplary embodiments of this invention have been described in detail above, those skilled in the art will readily appreciate that many other modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents, but also equivalent structures.

1. A wireless transmission method comprising:
receiving video signals from a video source,
receiving audio signals from an audio source;
combining the audio signals and the video signals so that the frequencies of the luminance video signal, the chrominance video signal, and the audio signals are substantially sequential in the frequency domain; and
transmitting the combined signals.

2. The method of claim 1 wherein the audio signal is a digital audio signal.

3. The method of claim 1 wherein the received audio signal is an analog audio signal and further comprising converting the analog audio signal to a digital audio signal before the step of combining.

4. The method of claim 1 wherein the video signals are composite video signals and wherein the step of combining is such that the frequency of the composite video signals is less than that of the digital audio signals.

5. The method of claim 1 further comprising band-limiting the composite video signals.

6. The method of claim 1 wherein the video signals are luminance and chrominance video signals and wherein the step of combining is such that the frequency of the digital audio signals is between the frequencies of the luminance video signals and the chrominance video signals.

7. The method of claim 6 further comprising modulating the chrominance signal onto a carrier frequency.

8. The method of claim 7 further comprising combining the luminance signal and the modulated chrominance signal before the step of transmitting.

9. The method of claim 1 wherein the video signals are luminance and chrominance video signals and wherein the step of combining is such that the frequency of the digital audio signals is greater than those of the luminance video signals and less than those of the chrominance video signals.

10. The method of claim 1 further comprising modulating the combined signals onto an RF carrier frequency before the step of transmitting.

11. The method of claim 1 further comprising encrypting the digital audio signal before the step of combining.

12. The method of claim 1 further comprising multiplexing the data portions of the digitized audio signal into one bit stream; adding synchronizing information to the bit stream; and adding a spreading code and/or an encryption code modulo-2 to the bit stream.

13. The method of claim 12 further comprising transforming the assembled bit stream to a bandwidth limited transmission code.

14. The method of claim 13 wherein the transmission code is selected from a group consisting of bi-phase digital coding, di-phase coding, Manchester coding, DDS FSK modulation of a carrier, FM modulation of a carrier, or ASK modulation of a carrier.

15. The method of claim 1 further comprising providing an antenna for transmitting the combined signals.

16. A wireless reception method comprising:
receiving signals containing luminance and chrominance video signals and a digital audio signal, wherein the frequencies of the luminance and chrominance video signals and the digital audio signal are substantially sequential within the combined signals;
separating the luminance and chrominance video signals and the digital audio signal from the combined signals;
sending the luminance and chrominance video signals to a video destination as separate video components;
converting the digital audio signal to an analog audio signal; and
sending the analog audio signal to an audio destination.

17. The method of claim 16 further comprising selecting a reception channel from channels provided by at least two receiving antennas.

18. A wireless transmission system comprising:
a first processor coupled to a video source, an audio source, and an antenna;
a second processor coupled to a video destination, an audio destination, and at least one antenna;
means associated with the first processor for converting an analog signal from the audio source into a digital audio signal;
means associated with the first processor for combining a luminance video signal and a chrominance video signal from the video source with the digital audio signal, wherein the combining places the luminance video signal, the chrominance video signal, and the digital audio signal in substantially sequential frequency slots;
means for transmitting the combined signals via the first antenna;
means for receiving the combined signals via the second antenna;
means associated with the second processor for separating the luminance and chrominance video signals and the digital audio signal from the combined signals;
means associated with the second processor for converting the digital audio signal to an analog audio signal; and
means associated with the second processor for sending the luminance and chrominance video signals to the video destination and for sending the analog audio signal to the audio destination.

19. The system of claim 18 wherein the means associated with the first processor for combining the luminance video signal, the chrominance video signal, and the digital audio signal is configured to combine the signals so that the frequency of the digital audio signal is between the frequency of the luminance video signal and the frequency of the chrominance video signal.

20. A wireless transmission system comprising:
a first processor coupled to a video source, an audio source, and an antenna;
a second processor coupled to a video destination, an audio destination, and at least one antenna;
means associated with the first processor for converting an analog signal from the audio source into a digital audio signal;
means associated with the first processor for combining a composite video signal from the video source with the digital audio signal, wherein the combining places the video signal and the digital audio signal in substantially sequential frequency slots;
means for transmitting the combined signals via the first antenna;
means for receiving the combined signals via the second antenna;
means associated with the second processor for separating the video signal and the digital audio signal from the combined signals;
means associated with the second processor for converting the digital audio signal to an analog audio signal; and
means associated with the second processor for sending the video signals to the video destination and for sending the analog audio signal to the audio destination.
